(19) United States
(12) Patent Application Publication
(10) Pub. No.: US 2018/0314276 A1
(43) Pub. Date: Nov. 1, 2018

(54) WIRELESS REFRIGERATION CONTROLLER AND CONTROL SYSTEM

(71) Applicant: Johnson Controls Technology Company, Auburn Hills, MI (US)

(72) Inventors: Tai P. Luc, South Milwaukee, WI (US); Szymon A. Jaworski, South Milwaukee, WI (US); Brian Cabrera, St. Francis, WI (US); Kevin C. Luty, West Allis, WI (US); Robert J. Borchardt, West Allis, WI (US)

(73) Assignee: Johnson Controls Technology Company, Auburn Hills, MI (US)

(21) Appl. No.: 15/965,233

(22) Filed: Apr. 27, 2018

Related U.S. Application Data
(60) Provisional application No. 62/492,105, filed on Apr. 28, 2017.

(51) Int. Cl. G05D 23/19; G05B 15/02; H04L 12/28

(52) U.S. Cl. CPC G05D 23/1917; H04L 12/2818; G05B 15/02

(57) ABSTRACT

An illustrative embodiment disclosed herein is a system including a mobile device configured to receive a user input requesting a first action to be performed by a refrigeration controller and encode the first requested action into a first command frame formatted for wireless transmission. The first command frame includes a first command code identifying the first requested action. The mobile device is further configured to send the first command frame from the mobile device to the refrigeration controller. The system further includes the refrigeration controller configured to extract the first command code from the first command frame, map the extracted first command code to the first requested action, and perform the first requested action in response to the mapping the extracted first command code to the first requested action.

### CROSS-REFERENCE TO RELATED PATENT APPLICATION

This application claims the benefit of and priority to U.S. Provisional Patent Application No. 62/492,105 filed Apr. 28, 2017, the entire disclosure of which is incorporated by reference herein.

### BACKGROUND

The present disclosure relates generally to refrigeration controllers and more particularly to a wireless control system for a refrigeration controller.

Heating, ventilation, air conditioning, and refrigeration (HVACR) systems can be found in a wide variety of settings, including grocery stores, hotels, restaurants, office buildings, cafeterias, and other types of buildings or structures. In these HVACR systems, there are many parameters to be controlled. Generally, these parameters are controlled using one or more controllers that are programmed at their respective site to satisfy the demands of the particular application in which the HVACR system is used.

### SUMMARY

An illustrative embodiment disclosed herein is a system including a mobile device configured to receive a user input requesting a first action to be performed by a refrigeration controller and encode the first requested action into a first command frame formatted for wireless transmission. The first command frame includes a first command code identifying the first requested action. The mobile device is further configured to send the first command frame from the mobile device to the refrigeration controller. The system further includes the refrigeration controller configured to extract the first command code from the first command frame, map the extracted first command code to the first requested action, and perform the first requested action in response to the mapping the extracted first command code to the first requested action.

In some embodiments, the mobile device is further configured to encode a second requested action into a second command frame formatted for wireless transmission. The second command frame may include a second command code identifying the second requested action. The second command code can be different from the first command code. The second command frame can include a first data field causing the second command frame to contain more bytes than the first command.

In some embodiments, the first requested action includes retrieving a sensor reading from memory within the refrigeration controller. The second requested action can include setting a temperature setpoint value. The first data field can include the temperature setpoint value.

In some embodiments, performing the first requested action includes retrieving a sensor reading from memory within the refrigeration controller.

In some embodiments, the first command frame further includes a checksum. The mobile device can be configured to calculate the checksum as a modulus of a sum of decimal values of standard ASCII characters in the first command frame and append the checksum to the first command frame.

In some embodiments, the refrigeration controller is further configured to encode a first result of performing the first requested action into a first response frame formatted for wireless transmission. The first response frame can include a first response code identifying the first result of performing the first requested action. The refrigeration controller can include sending the first response frame from the refrigeration controller to the mobile device.

In some embodiments, the first response code is generated by appending the first result identifier to the first command code.

In some embodiments, the refrigeration controller further configured to encode a second result of performing the second requested action into a second response frame formatted for wireless transmission. The second response frame can include a second response code identifying the second result of performing the second requested action. The second response code can be different from the first response code. The first response frame can include a second data field causing the first response frame to contain more bytes than the second response frame.

In some embodiments, the system further includes a bridge device. The bridge device can be configured to receive the first command frame from the mobile device and send the first command frame to the refrigeration controller.

An illustrative embodiment disclosed herein is a method for monitoring and controlling a refrigeration controller via a mobile device, the method including receiving, at the mobile device, a user input requesting a first action to be performed by the refrigeration controller and encoding, by the mobile device, the first requested action into a first command frame formatted for wireless transmission. The first command frame includes a first command code identifying the first requested action. The method further includes sending the first command frame from the mobile device to the refrigeration controller, extracting, by the refrigeration controller, the first command code from the first command frame, mapping the extracted first command code to the first requested action, and performing, by the refrigeration controller, the first requested action in response to the mapping the extracted first command code to the first requested action.

In some embodiments, the method further includes encoding, by the mobile device, a second requested action into a second command frame formatted for wireless transmission. The second command frame can include a second command code identifying the second requested action. The second command code can be different from the first command code. The second command frame can include a first data field causing the second command frame to contain more bytes than the first command frame.

In some embodiments, the second requested action includes setting a temperature setpoint value. The first data field can include the temperature setpoint value.

In some embodiments, performing the first requested action includes retrieving a sensor reading from memory within the refrigeration controller.

In some embodiments, the first command frame further includes a checksum. The method can include calculating the checksum as a modulus of a sum of decimal values of standard ASCII characters in the first command frame and appending the checksum to the first command frame.

In some embodiments, the method further includes encoding, by the refrigeration controller, a first result of performing the first requested action into a first response frame formatted for wireless transmission. The first response frame can include a first response code identifying the first result of performing the first requested action. The method can include sending the first response frame from the refrigeration controller to the mobile device.

In some embodiments, the first response code is generated by appending the first result identifier to the first command code.

In some embodiments, the method further includes encoding, by the refrigeration controller, a second result of performing a second requested action into a second response frame formatted for wireless transmission. The second response frame can include a second response code identifying the second result of performing the second requested action. The second response code can be different from the first response code. The first response frame can include a second data field causing the first response frame to contain more bytes than the second response frame.

In some embodiments, the method further includes receiving, by a bridge device, the first command frame from the mobile device. The method can include sending, by the bridge device, the first command frame to the refrigeration controller.

An illustrative embodiment disclosed herein is a non-transitory computer-readable storage medium having instructions stored thereon that, upon execution by a computing device, cause the computing device to perform operations including receiving a user input requesting a first action to be performed by a refrigeration controller and encoding the first requested action into a first command frame formatted for wireless transmission. The first command frame includes a first command code identifying the first requested action. The operations further include sending the first command frame from a mobile device to the refrigeration controller, extracting the first command code from the first command frame, mapping the extracted first command code to the first requested action, and performing the first requested action in response to the mapping the extracted first command code to the first requested action.

In some embodiments, the operations further includes encoding a second requested action into a second command frame formatted for wireless transmission. The second command frame includes a second command code identifying the second requested action. The second command code can be different from the first command code. The second command frame can include a first data field causing the second command frame to contain more bytes than the first command frame.

### BRIEF DESCRIPTION OF THE DRAWINGS

FIG. 1 is a block diagram of a wireless refrigeration controller system, according to an exemplary embodiment.

FIG. 2 is a block diagram of the refrigeration controller as shown in the system of FIG. 1, according to an exemplary embodiment.

FIG. 3 is a block diagram of the mobile device as shown in the system of FIG. 1, according to an exemplary embodiment.

FIG. 4 is a block diagram of the bridge device as shown in the system of FIG. 1, according to an exemplary embodiment.

FIG. 5A is a drawing of the command frame as shown in the system of FIG. 1, according to an exemplary embodiment.

FIG. 5B is a drawing of the response frame as shown in the system of FIG. 1, according to an exemplary embodiment.

FIG. 6 is an illustration of a scan mode of the graphical user interface, according to an exemplary embodiment.

FIG. 7 is an illustration of a status mode of the graphical user interface, according to an exemplary embodiment.

FIG. 8 is an illustration of a setup mode of the graphical user interface, according to an exemplary embodiment.

FIG. 9 is a flowchart of a process for communicating between the refrigeration controller and the mobile device in the system of FIG. 1, according to an exemplary embodiment.

FIG. 10 is a flowchart of a process of connecting the mobile device to the refrigeration controller in the system of FIG. 1, according to an exemplary embodiment.

FIG. 11 is a flowchart of a process for sending the command frame by the mobile device in the system of FIG. 1, according to an exemplary embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

In the heating, ventilation, air conditioning, and refrigeration (HVACR) systems, there are many parameters to be controlled. For example, commercial refrigeration systems may have controllers that are dedicated for control of humidity, pressure, temperature, and so forth, including set points or ranges for a number of different devices in the refrigeration system (e.g., fans, alarms, sensors).

Such controllers may include ports that enable connection to devices that transmit information to program the controllers with appropriate set point information or similar data. However, this generally involves physical connection between the controllers and programming devices. Indeed, in situations where it is desirable to quickly change set points or other parameters, physical intervention is often necessary. In accordance with present embodiments, it is now recognized that there is a technological need to equip such controllers with wireless communication capability customized for the refrigeration infrastructure.

Disclosed herein is a refrigeration wireless controller using custom commands. The custom commands are encoded from human-friendly language. The custom commands are transmitted from a mobile device to the refrigeration controller, where the custom commands are mapped to commands readable by the refrigeration controller. The technological solution offers uploading wirelessly system parameters specific for refrigeration systems. It also offers monitoring temperature and alarm events. Finally, it offers downloading wirelessly current system settings. In one embodiment, a refrigeration controller may be outfitted with or otherwise integrated with a wireless communication system, such as a Bluetooth communication system.

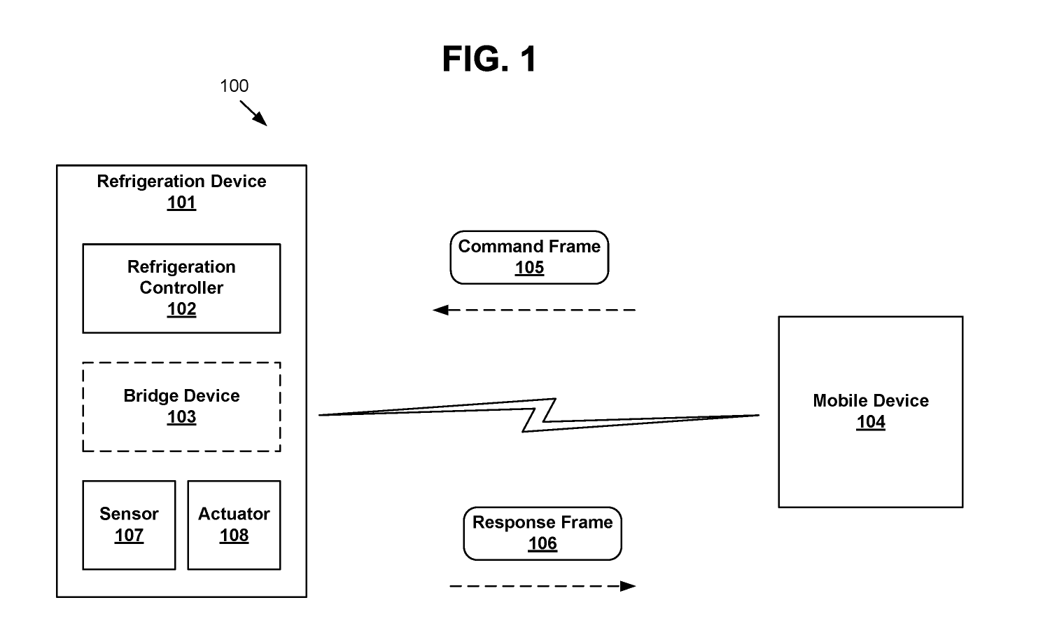

FIG. 1 illustrates a block diagram of a wireless refrigeration controller system 100, according to an exemplary embodiment. The refrigeration controller system 100 is shown to include an refrigeration device 101 and a mobile device 104.

The refrigeration device 101 is shown to include a refrigeration controller 102. The refrigeration controller 102 can be configured to receive a command frame 105 from the mobile device 104. In some embodiments, the refrigeration controller 102 is further configured to wirelessly receive the command frame 105. In other embodiments, the refrigeration controller 102 is further configured to receive the command frame 105 through a wired interface such as a serial bus interface. The refrigeration controller 102 can be configured to extract a command code from the command frame 105 (described in greater detail below) and map the extracted command code to a requested action by a user. The refrigeration controller 102 can be configured to perform the requested action in response to mapping the extracted command code to the requested action.

The refrigeration controller 102 can be configured to encode a result of performing the requested action into a response frame 106 formatted for wireless transmission, the response frame 106 comprising a first response code identifying the first result of performing the first requested action (described in greater detail below). The refrigeration controller 102 can be configured to send the response frame 106 to the mobile device 104. In some embodiments, the refrigeration controller 102 is further configured to wirelessly send the command frame 105. In other embodiments, the refrigeration controller 102 is further configured to send the command frame 105 through a wired interface such as a serial bus interface.

The refrigeration device 101 may include a sensor 107 and an actuator 108. The sensor 107 may be configured to sense a temperature within the refrigeration device 101. The actuator 108 may be configured to increase or decrease the temperature within the refrigeration device 101 until the temperature matches a temperature setpoint value received by the refrigeration controller 102.

In some embodiments, the refrigeration device 101 includes a bridge device 103 coupled via a serial bus link to the refrigeration controller 102. The bridge device 103 may be configured to wirelessly receive the command frame 105 from the mobile device 104 and to forward the command frame 105 to the refrigeration controller 102 via a serial bus interface. In some embodiments, the bridge device 103 is configured to receive the response frame 106 from the refrigeration controller 102 via the serial bus interface and to forward the response frame 106 to the mobile device 104 wirelessly. The bridge device 103 may be configured to extract the command code from the command frame 105 and map the extracted command code to the requested action by a user. The bridge device 103 may be configured to encode a result of performing the requested action into the response frame 106 formatted for wireless transmission. In some embodiments, the bridge device 103 is a stand-alone device that plugs into the refrigeration device 101 at a serial bus port.

The mobile device 104 may be wirelessly coupled to the refrigeration controller 102. In some embodiments, the mobile device 104 is wirelessly coupled directly to the refrigeration controller 102. In other embodiments, the mobile device 104 is wirelessly coupled to the bridge device 103. The mobile device 104 can be configured to receive a user input requesting an action to be performed by the refrigeration controller 102. In some embodiments, the mobile device 104 is configured to encode the requested action into the command frame 105 formatted for wireless transmission. The mobile device 104 can be configured to send the command frame 105 to the refrigeration controller 102. In some embodiments, the mobile device 104 is configured to receive the response frame 106 from the refrigeration controller 102. The mobile device 104 can be configured to extract the response code from the response frame 106 and map it to a human-friendly message responding to the user input request.

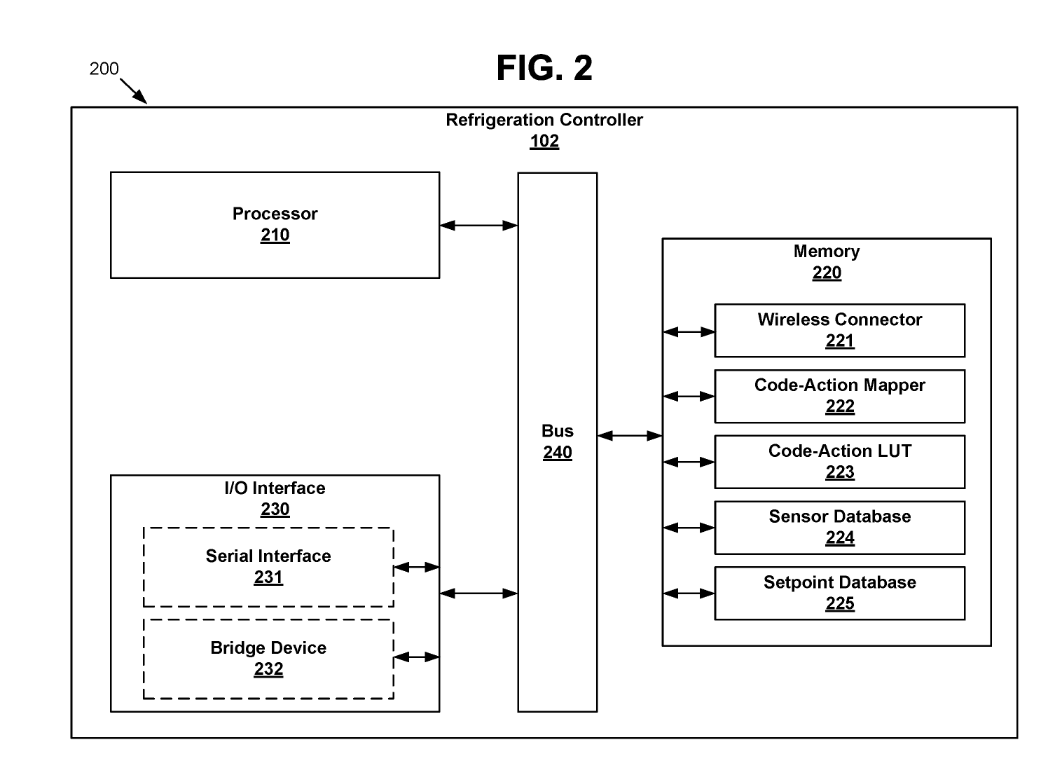

FIG. 2 is a block diagram 200 of the refrigeration controller 102 as shown in the system of FIG. 1, according to an exemplary embodiment. The refrigeration controller 102 is shown to include a processor 210, a memory 220, an input/output (I/O) interface 230, and a bus 240. The processor 210, the memory 220, and the I/O interface 230 may be coupled to each other via the bus 240. The processor 210 can be configured to store data, fetch data and execute computer code, applications, and/or instructions stored in the memory 220.

The memory 220 can be configured to store data, computer code, applications and/or instructions for execution by the processor 210. The memory 220 may include random access memory (RAM), read-only memory (ROM), hard drive storage, temporary storage, cache, volatile memory, non-volatile memory, flash memory, optical memory, or any other suitable memory for storing software objects and/or computer instructions. In some embodiments, the memory 220 includes database components, object code components, script components, or any other type of information structure for supporting the various activities and information structures described in the present disclosure.

The memory 220 is shown to include a wireless connector 221, a code-action mapper 222, code-action look-up-table (LUT) 223, and a sensor database 224 and setpoint database 225. The wireless connector 221 may be configured to pair the refrigeration controller 102 with the mobile device 104. In some embodiments, the wireless connector 221 stores a first passkey in memory 220, receives a second passkey from the mobile device 104, compares the first passkey to the second passkey, and in response to the first passkey and the second passkey matching, pairs the refrigeration controller 102 with the mobile device 104. The processor 210 may be configured to cause the refrigeration controller 102 to pair with the wireless client by executing the wireless connector 221. The wireless connector 221 may be implemented as instructions stored on the memory 220. The wireless connector 221 may be implemented as software running of an operating system or as a software application installed on the refrigeration controller 102. In other embodiments, the wireless connector 221 is implemented as a circuit, such as a field-programmable gate array (FPGA) or an application-specific integrated circuit (ASIC). In yet other embodiments, the wireless connector 221 is implemented as a separate computing device. In some embodiments, the wireless connector 221 may be a member of the bridge device 232.

The code-action mapper 222 may be configured to map the command code to the user-requested action by using the code-action LUT 223. For example, the code-action mapper 222 may match the command code to a value with a corresponding index in a first array. The code-action mapper 222 may read the requested action with the same index in the second array. In some embodiments, the code-action mapper 222 is further configured to encode the result of performing the requested action into the response frame 106 formatted for wireless transmission by using the code-action LUT 223. In some embodiments, the code-action mapper 222 is a member of the wireless connector 221. The processor 210 can be configured to cause the refrigeration controller 102 to perform the aforementioned tasks by executing the code-action mapper 222. The code-action mapper 222 may be implemented as instructions stored on the memory 220. The code-action mapper 222 may be implemented as software running of an operating system or as a software application installed on the refrigeration controller 102. In other embodiments, the code-action mapper 222 is implemented as a circuit, such as a field-programmable gate array (FPGA) or an application-specific integrated circuit (ASIC). In yet other embodiments, the code-action mapper 222 is implemented as a separate computing device.

The sensor database 224 can be configured to store temperature values measured by the sensors 107 in the refrigeration device 101. Each value may correspond to one sensor 107. The setpoint database 225 may be configured to store a temperature setpoint value corresponding to the actuator 108. The temperature setpoint value can be the target temperature for the inside of the refrigeration device 101. The setpoint database 225 may be configured to store multiple setpoint values. Each of the setpoint values may correspond to a unique time. For example, the first setpoint may correspond to 8 am, and the second setpoint may correspond to 8 pm.

The I/O interface 230 is shown to include at least one of a serial interface 231 and bridge device 232. The serial interface 231 can be configured to receive data via a serial bus. Examples of a serial interface 231 are universal serial bus (USB) interface and universal asynchronous receiver-transmitter (UART) interface. In some embodiments, the bridge device 232 is same as the bridge device 103, except that the bridge device 232 is integrated within the refrigeration controller 102. The bridge device 232 can be configured to receive data wirelessly. Examples of wireless standards are Bluetooth, Bluetooth Low Energy (BLE), WiFi, Infrared, and cellular network standards. Examples of cellular network standards include Global System for Mobile communications (GSM), Code Division Multiple Access 2000 (CDMA2000), Wideband Code Division Multiple Access (W-CDMA), and Long-term evolution (LTE). The bridge device 232 can be configured to transform the data from wireless communication to serial communication, which is one mode of communication in computing devices. The bridge device 232 may be implemented as one or more transistor circuits. In other embodiments, the bridge device 232 is implemented as a separate computing device. The I/O interface 230 can include a modem, a transceiver, an Ethernet card, a peripheral component interconnect express (“PCIe”) card, a network interface controller (“NIC) for communicating with a wire-based network, or a wireless network interface controller (“WNIC) for communicating with a wireless network.

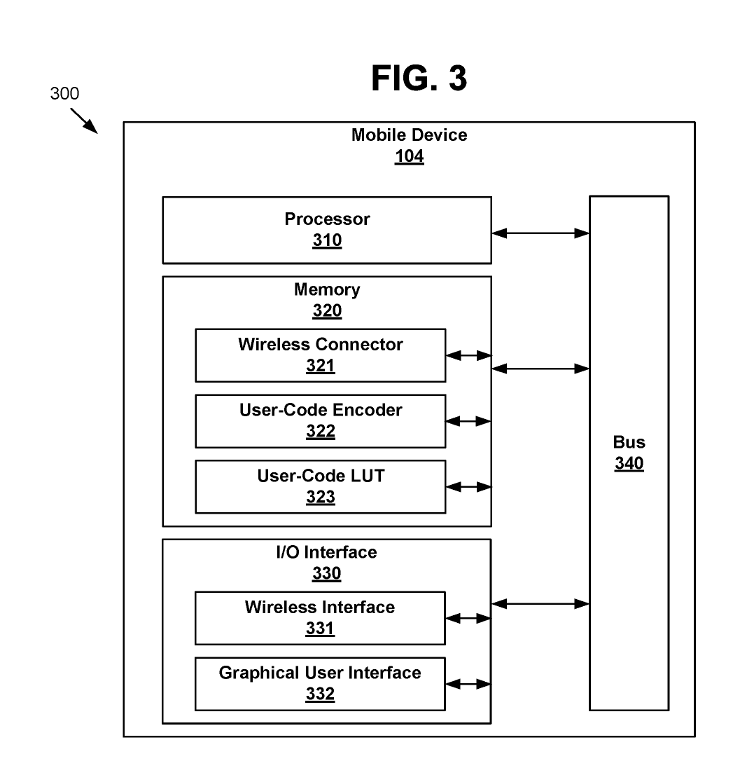

FIG. 3 is a block diagram 300 of the mobile device 104 as shown in the system of FIG. 1, according to an exemplary embodiment. The mobile device 104 is shown to include a processor 310, a memory 320, an input/output (I/O) interface 330, and a bus 340. The bus 340 may couple the processor 310, the memory 320, and the I/O interface 330 to each other. The processor 310 can be configured to store data, fetch data, execute computer code, applications, and/or instructions stored in the memory 320.

The memory 320 can be configured to store data, computer code, applications and/or instructions for execution by the processor 310. The memory 320 may include random access memory (RAM), read-only memory (ROM), hard drive storage, temporary storage, cache, volatile memory, non-volatile memory, flash memory, optical memory, or any other suitable memory for storing software objects and/or computer instructions. In some embodiments, the memory 320 includes database components, object code components, script components, or any other type of information structure for supporting the various activities and information structures described in the present disclosure.

The memory 320 is shown to include a wireless connector 321, an user-code encoder 322, and a user-code LUT 323. The wireless connector 321 may be configured to request pairing of the mobile device 104 with the refrigeration controller 102. In some embodiments, the wireless connector 221 retrieves a first passkey from memory 220, sends the first passkey to the refrigeration controller 102, and in response to the refrigeration controller 102 matching the first passkey and a second passkey, receives acknowledgement of the pairing. The user-code encoder 322 may be configured to receive a user input from the graphical user interface (GUI) 332 requesting the action to be performed by the refrigeration controller 102. The user-code encoder 322 can be configured to encode the requested action into the command frame 105 formatted for wireless transmission by using the user-code LUT 323. For example, the user-code encoder 322 may match the requested action to a value with a corresponding index in a first array. The user-code encoder 322 may read the command code with the same index in the second array. The user-code encoder 322 may generate the command frame 105 by appending the command code with other fields, such as a checksum field or a data field.

The user-code encoder 322 can be configured to extract the response code from the response frame 106 and map it to a human-friendly message responding to the user input request by using the user-code LUT 323. In some embodiments, the user-code encoder 322 is a member of the wireless connector 321. The processor 310 may be configured to cause the mobile device 104 to perform each or any of the aforementioned tasks by executing the wireless connector 321 and/or the user-code encoder 322. The wireless connector 321 and/or the user-code encoder 322 may be implemented as instructions stored on the memory 320. The wireless connector 321 and/or the user-code encoder 322 may be implemented as software running of an operating system or as a software application installed on the mobile device 104. In other embodiments, the wireless connector 321 and/or the user-code encoder 322 are implemented as a circuit, such as a field-programmable gate array (FPGA) or an application-specific integrated circuit (ASIC). In yet other embodiments, the wireless connector 321 and/or the user-code encoder 322 are implemented as a separate computing device.

The I/O interface 330 is shown to include the wireless interface 331 and the GUI 332. The GUI 332 can be configured to display options for a user for monitoring and for updating system parameters of the refrigeration device 101. In some embodiments, the GUI 332 is further configured to receive the user inputs from the user and to forward them to wireless connector 321. The GUI 332 can be configured to display a human-friendly response decoded from the response frame 106. The GUI 332 may be implemented as instructions stored on the memory 320. The GUI 332 may be implemented as software running of an operating system or as a software application installed on the mobile device 104. The I/O interface 330 may further include a modem, a transceiver, an Ethernet card, a peripheral component interconnect express (“PCIe”) card, a network interface controller (“NIC) for communicating with a wire-based network, or a wireless network interface controller (“WNIC”) for communicating with a wireless network.

The wireless interface 331 can be configured to receive the command frame 105 from the wireless connector 321. In some embodiments, the wireless interface 331 is configured to wirelessly transmit the command frame 105. The wireless interface 331 is further configured to wirelessly receive the response frame 106. In some embodiments, the wireless interface 331 is configured to communicate using Bluetooth, BLE, WiFi, Infrared, and cellular network standards. Examples of cellular network standards include GSM, CDMA2000, W-CDMA, and LTE. The wireless interface 331 may be implemented as one or more transistor circuits. In other embodiments, the wireless interface 331 is implemented as a separate computing device.

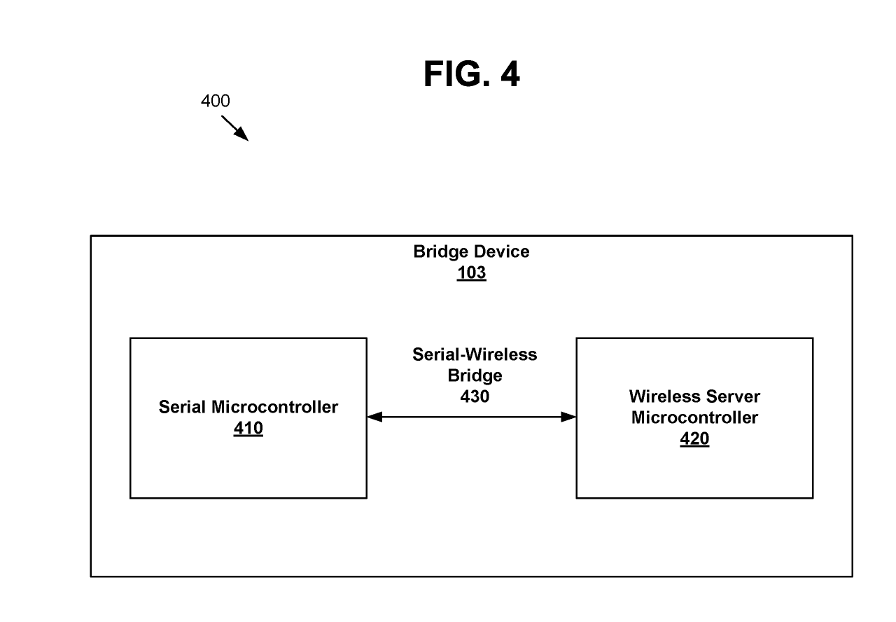

FIG. 4 is a block diagram 400 of the bridge device 103 as shown in the system 100 of FIG. 1, according to an exemplary embodiment. The bridge device 103 is shown to include a serial microcontroller 410, a wireless server microcontroller 420, and a serial-wireless bridge 430. In some embodiments, the serial microcontroller 410 is configured to send the command frame 105 serially to the serial interface 231. In other embodiments, the serial microcontroller 410 is configured to send the command frame 105 serially to the code-action mapper 222. In some embodiments, the command frame 105 is sent using USB protocol. In other embodiments, the command frame 105 is sent using UART protocol.

The wireless server microcontroller 420 can be configured to receive the command frame 105 wirelessly from the mobile device 104. In some embodiments, the command frame 105 is received using the BLE protocol. In other embodiments, the command frame 105 is received using Bluetooth, WiFi, Infrared, GSM, CDMA2000, W-CDMA, or LTE. The serial-wireless bridge 430 can be configured to couple the wireless server microcontroller 420 to the serial microcontroller 410. In some embodiments, the functions of the serial microcontroller 410 and the serial-wireless bridge 430 are combined in one wireless-to-serial microcontroller (not shown).

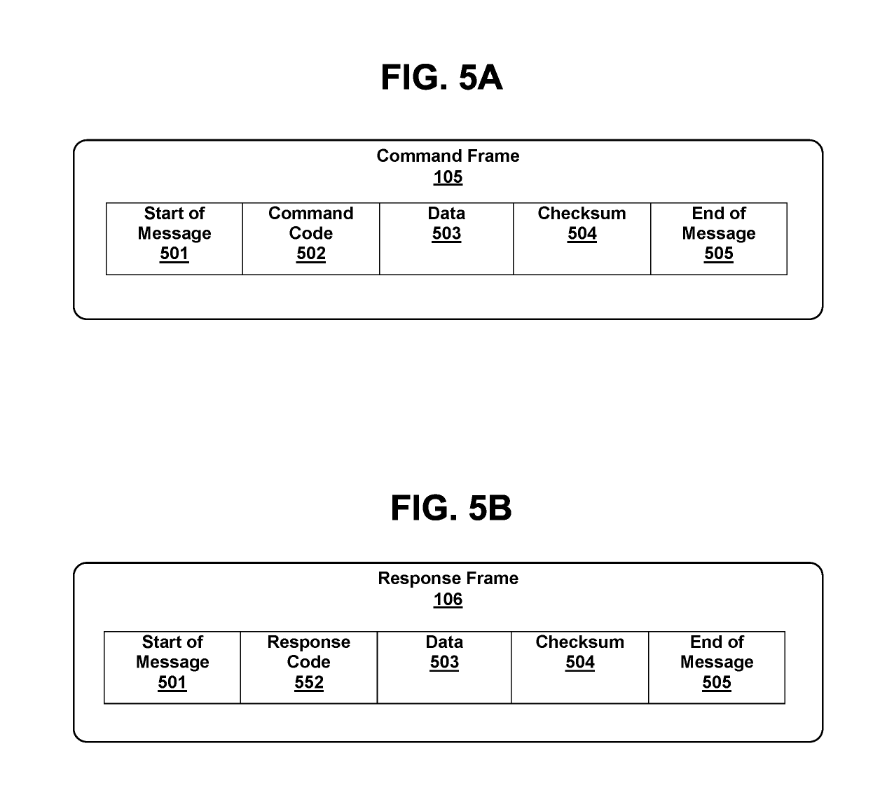

FIG. 5A is a drawing of the command frame 105 as shown in the system of FIG. 1, according to an exemplary embodiment. Communication protocol between the refrigeration controller 102 and the mobile device 104 is based on a server-client model. The mobile device 104 can be configured as the client, initiating a transaction by sending the command frame 105 to the refrigeration controller 102. The refrigeration controller 102 can be configured as the server, sending the response frame 106 back acknowledging that the command was received and executed. The response frame 106 may contain data in some cases. Response frames 106 may be encoded using standard ASCII characters.

Before beginning communication with the refrigeration controller 102, the wireless connector 321 of the mobile device 104 may be configured to search and to request pairing with the refrigeration controller 102. The wireless connector 221 of the refrigeration controller 102 may be configured to pair the mobile device 104 with the refrigeration controller 102.

The command frame 105 is shown to include a command code 502. The command frame 105 may include start of message 501 character, checksum 504, and end of message 505. The command frame 105 may contain data 503 when applicable. The command frame 105 can be logically partitioned into units called fields. Each of the blocks illustrated in the drawing of the command frame 105 in FIG. 5 is a field of the fields.

The command code 502 can correspond to the user input requesting the action. Examples of the command code 502 are “G1”, “G2”, “S1”, “S2”, “S3”, “S4”, and “S5”. “G1” may correspond to a first requested action to retrieve a first sensor 107 temperature. The first requested action may include the processor 210 of the refrigeration controller 102 retrieving a sensor reading from the sensor database 224 of the memory 220 within the refrigeration controller 102. “G2” can correspond to a first requested action to retrieve a second sensor 107 temperature. In some embodiments, “S1” corresponds to a third requested action to set system name. “S2” may correspond to a fourth requested action to set temperature setpoint value. The fourth requested action may include the processor 210 writing a temperature setpoint value to an address in the setpoint database 225. The actuator 108 may periodically read the address in the setpoint database 225 at a pre-determined rate. “S3” may correspond to a fifth requested action to set defrost type as off-cycle, electric, or hot-gas. In some embodiments, “S4” corresponds to a sixth requested action to set temperature units. “S5” may correspond to a seventh requested action set fan type as 1-speed or 2-speed. Different command frames 105 may contain different command codes 502.

Some command frames 105 contain data 503 whereas other command frames 105 don't contain data 503. Adding the data 503 to a first command frame 105 can cause the first command frame 105 to contain more bytes than a second command frame 105 that does not contain the data 503. The data 503 could vary in length in which case each data 503 byte may be comma delimited.

The checksum 504 can be expressed as a two-character ASCII representation. The user-code encoder 322 of the mobile device 104 may be configured to calculate the checksum 504 by taking a modulus of a sum of all ASCII characters (decimal values) in the command frame 105. In some embodiments, the checksum 504 is calculated using only the fields preceding the checksum 504. In one embodiment, the checksum 504 is calculated using the start of message 501 and the command code 502. For values less than 10, a preceding “0” may be used. For command frames 105 with data 503 greater than 1, the delimiter characters may be included in the checksum 504 operation. The user-code encoder 322 can be configured to append the calculated checksum 504 to the command frame 105.

FIG. 5B is a drawing of the response frame 106 as shown in the system of FIG. 1, according to an exemplary embodiment. The response frame 106 is shown to include a response code 552. The response frame 106 can include a start of message 501 character, checksum 504, and end of message 505. The response frame 106 may contain data 503 when applicable. The response frame 106 can be logically partitioned into the fields as described in FIG. 4. Each of the blocks illustrated in the drawing of the response frame 106 in FIG. 5 is a field of the fields.

The response code 552 can include a result identifier. The response code 552 may also include the command code 502. In some embodiments, the code-action mapper 222 of the refrigeration controller 102 is configured to generate the result identifier based at least on whether the command code 502 was successful and whether checksum 504 generates an error for the command code 502. The code-action mapper 222 may be further configured to append the result identifier to the command code 502. Examples of the result identifiers are “OK”, “E1”, “E2”, and “E3”. “OK” may indicate that the command code 502 was successful. “E1” may indicate that the checksum 504 generated an error. “E2” may indicate that the command code 502 is invalid. “E3” may indicate that the command frame 105 length is invalid.

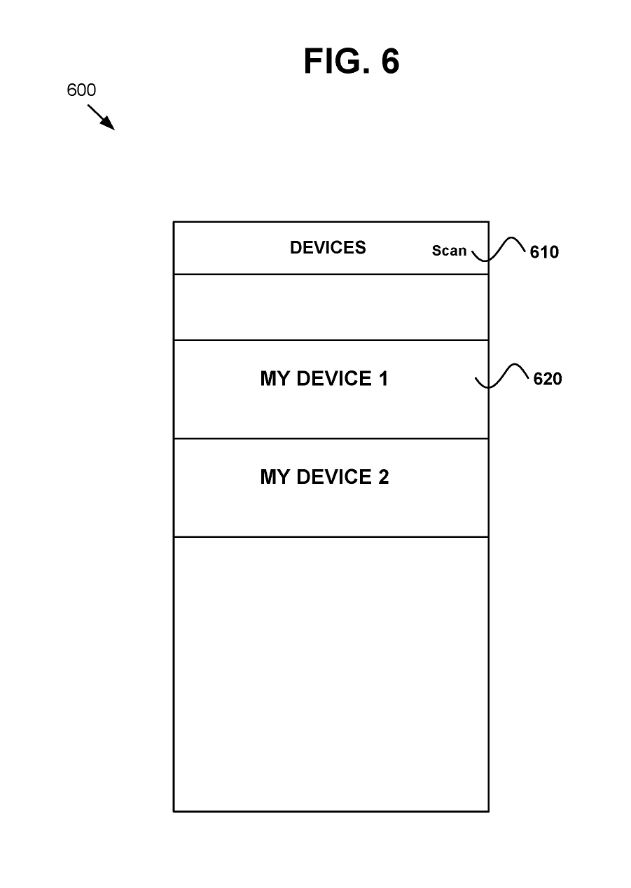

FIG. 6 is an illustration of a scan mode 600 of the GUI 332, according to an exemplary embodiment. The scan mode 600 is shown to include a status 610 and a list of devices 620. While the mobile device 104 is in the scan mode 600, the status 610 can be configured to display “scan.” In some embodiments, when the scan is complete, the status 610 is configured to say “scan complete.” The list of devices 620 can be configured to display the name of all wireless devices within range of the mobile device 104 that are capable of being paired with the mobile device 104.

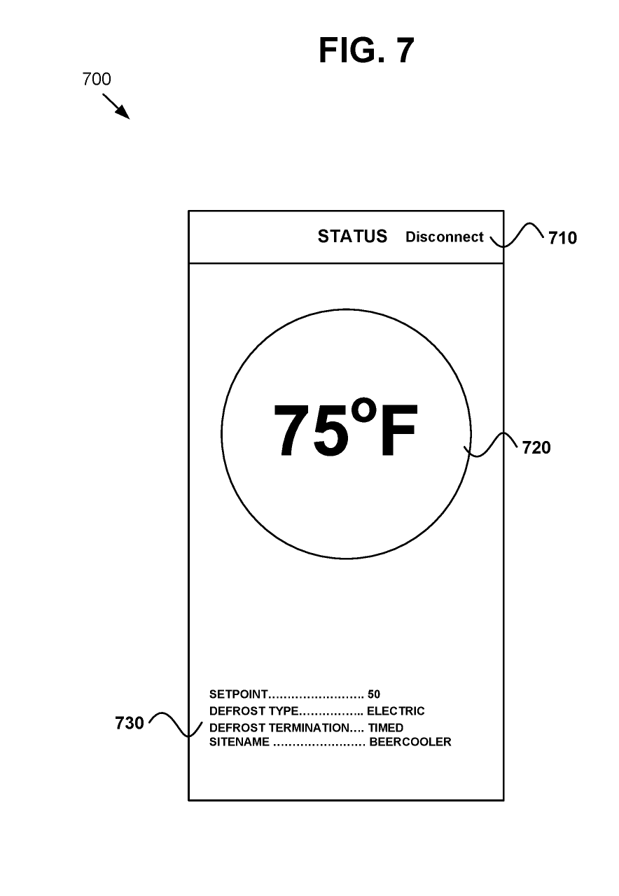

FIG. 7 is an illustration of a status mode 700 of the GUI 332, according to an exemplary embodiment. The status mode 700 can include a status 710, a temperature display 720, and a parameters display 730. The status 710 can be configured to display “connected” when the mobile device 104 is paired with another device, such as the refrigeration controller 102. In some embodiments, the status 710 is further configured to display “disconnected” when the mobile device 104 is not paired with another device. The temperature display 720 can be configured to display the most recent temperature received by the mobile device 104 from the refrigeration controller 102. The parameters display 730 can display a parameter list populated with most recent parameters values received by the mobile device 104 from the refrigeration controller 102. The parameter list is shown to include setpoint, defrost type, defrost termination, and site name.

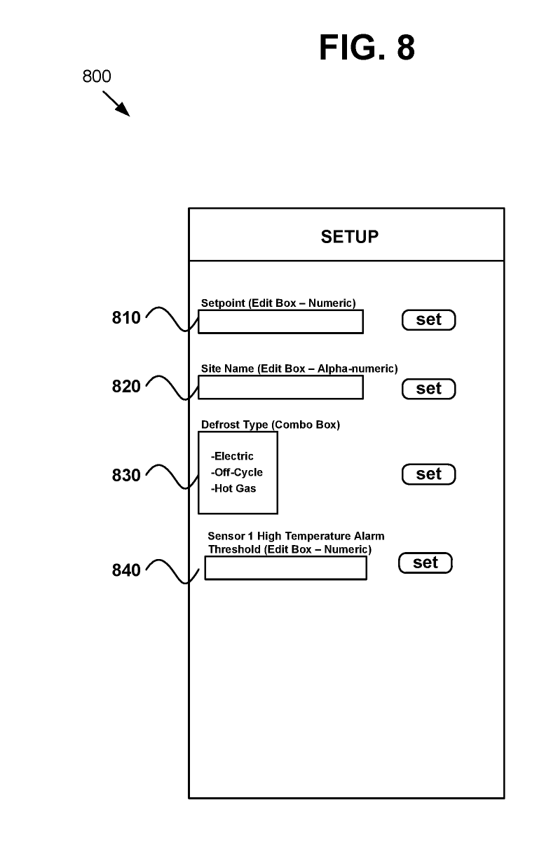

FIG. 8 is an illustration of a setup mode 800 of the graphical user interface 332, according to an exemplary embodiment. The setup mode 800 is shown to include the setpoint box 810, the site name box 820, the defrost type box 830, and the high temperature alarm threshold box 840. Each of the boxes 810-840 can be configured to receive user inputs for the respective parameters.

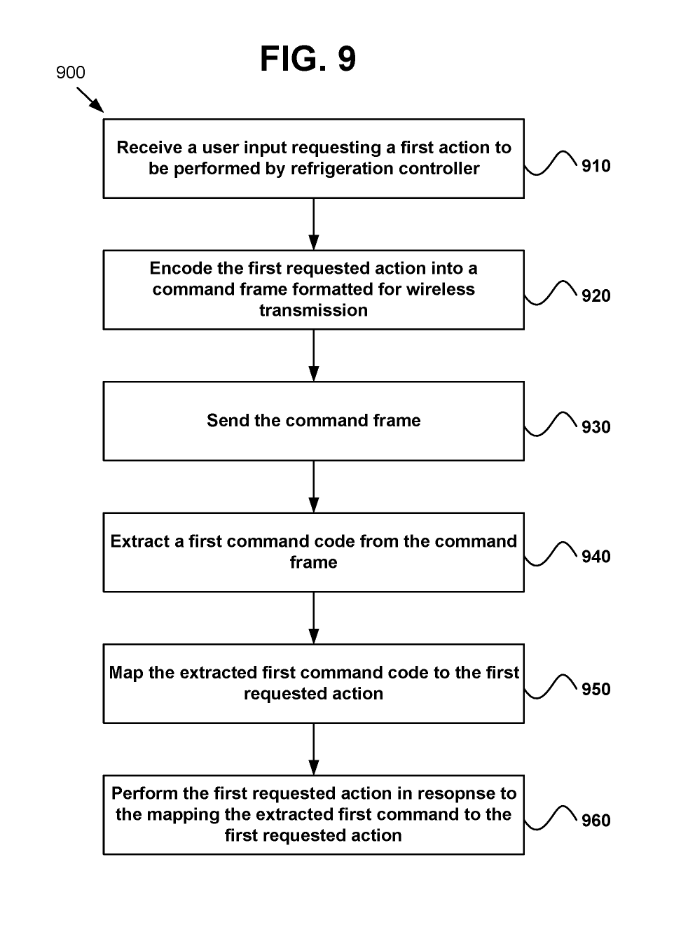

FIG. 9 is a flowchart of a process 900 for communicating between the refrigeration controller 102 and the mobile device 104 in the system of FIG. 1, according to an exemplary embodiment. At step 910, the mobile device 104 may receive a user input requesting a first action to be performed by the refrigeration controller 102. At step 920, the mobile device 104 can encode the first requested action into a first command frame 105 formatted for wireless transmission. The first command frame 105 may comprise a first command code 502 identifying the first requested action. At step 930, the mobile device 104 may send the command frame 105 to the refrigeration controller 102. At step 940, the refrigeration controller 102 can extract the first command from the first command frame 105. At step 950, the refrigeration controller 102 may map the extracted first command code 502 to the first requested action. Mapping the extracted first command code 502 to the first requested action may be in response to the extracting the first command from the first command frame 105. At step 960, the refrigeration controller 102 can perform the first requested action in response to the mapping the extracted first command code 502 to the first requested action.

In some embodiments, in response to the performing the first requested action, the refrigeration controller 102 encodes a first result of performing the first requested action into a first response frame 106 formatted for wireless transmission. The first response frame 106 may comprise a first response code 552 identifying the first result of performing the first requested action. In some embodiments, the refrigeration controller 102 sends the first response frame 106 to the mobile device 104. In some embodiments, the mobile device 104 extracts the first response code 552 from the first response frame 106 and maps it to a human-friendly message responding to the user input request.

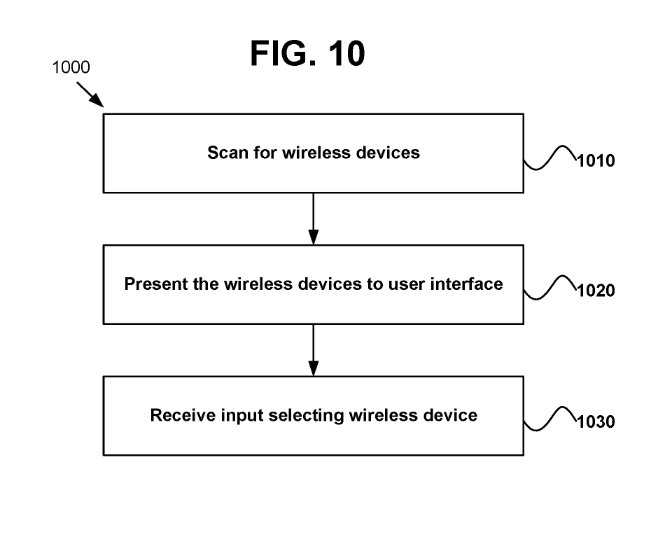

FIG. 10 is a flowchart of a process 1000 of connecting the mobile device 104 to the refrigeration controller 102 (or alternatively, bridge device 103) in the system of FIG. 1, according to an exemplary embodiment. At step 1010, the mobile device 104 may scan for wireless devices that use the same wireless protocol that the mobile device 104 uses. At step 1020, mobile device 104 can present the wireless devices to the GUI 332. At step 1030, the mobile device 104 may receive input selecting one of the wireless devices.

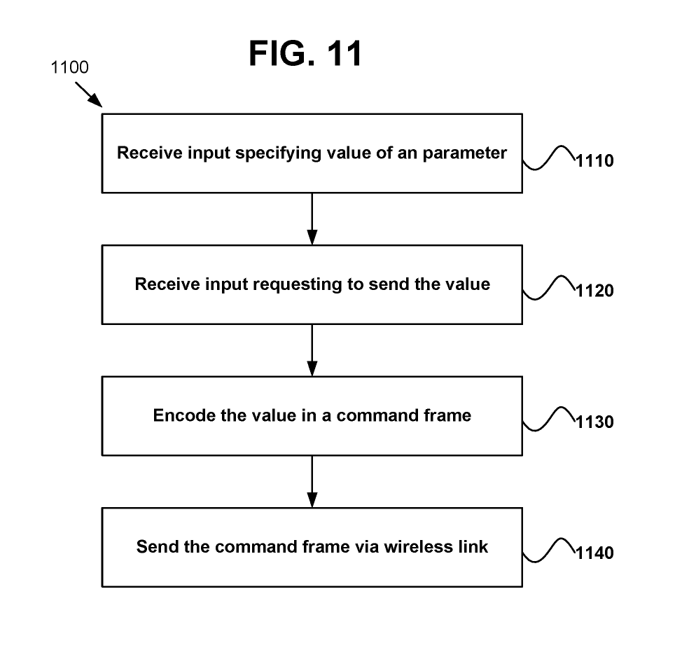

FIG. 11 is a flowchart of a process 1100 for sending the command frame 105 by the mobile device 104 in the system of FIG. 1, according to an exemplary embodiment. At step 1110, the mobile device 104 may receive input specifying value of a parameter from the GUI 332. At step 1120, the mobile device 104 can receive input requesting to send the value from the GUI 332. At step 1130, the mobile device 104 may encode the value in the command frame 105. At step 1140, the mobile device 104 can send the command frame 105.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system comprising:
a mobile device configured to:
receive a user input requesting a first action to be performed by a refrigeration controller;
encode the first requested action into a first command frame formatted for wireless transmission, the first command frame comprising a first command code identifying the first requested action;
send the first command frame from the mobile device to the refrigeration controller; and
the refrigeration controller configured to:
extract the first command code from the first command frame and map the extracted first command code to the first requested action; and
perform the first requested action in response to the mapping the extracted first command code to the first requested action.

2. The system of claim 1, the mobile device further configured to encode a second requested action into a second command frame formatted for wireless transmission, the second command frame comprising a second command code identifying the second requested action,
wherein the second command code is different from the first command code, and wherein the second command frame comprises a first data field causing the second command frame to contain more bytes than the first command.

3. The system of claim 2, wherein the first requested action comprises retrieving a sensor reading from memory within the refrigeration controller, wherein the second requested action comprises setting a temperature setpoint value, and wherein the first data field comprising the temperature setpoint value.

4. The system of claim 1, wherein performing the first requested action comprises retrieving a sensor reading from memory within the refrigeration controller.

5. The system of claim 1, the first command frame further comprises a checksum, the mobile device further configured to:
calculate the checksum as a modulus of a sum of decimal values of standard ASCII characters in the first command frame; and
append the checksum to the first command frame.

6. The system of claim 1, the refrigeration controller further configured to:
encode a first result of performing the first requested action into a first response frame formatted for wireless transmission, the first response frame comprising a first response code identifying the first result of performing the first requested action; and
send the first response frame from the refrigeration controller to the mobile device.

7. The system of claim 6, wherein the first response code is generated by appending the first result identifier to the first command code.

8. The system of claim 6, the refrigeration controller further configured to:
encode a second result of performing the second requested action into a second response frame formatted for wireless transmission, the second response frame comprising a second response code identifying the second result of performing the second requested action,
wherein the second response code is different from the first response code, wherein the first response frame comprises a second data field causing the first response frame to contain more bytes than the second response frame.

9. The system of claim 1, the system further comprising a bridge device, the bridge device configured to:
receive the first command frame from the mobile device; and
send the first command frame to the refrigeration controller.

10. A method for monitoring and controlling a refrigeration controller via a mobile device, the method comprising:
receiving, at the mobile device, a user input requesting a first action to be performed by the refrigeration controller;
encoding, by the mobile device, the first requested action into a first command frame formatted for wireless transmission, the first command frame comprising a first command code identifying the first requested action;
sending the first command frame from the mobile device to the refrigeration controller;
extracting, by the refrigeration controller, the first command code from the first command frame and mapping the extracted first command code to the first requested action; and
performing, by the refrigeration controller, the first requested action in response to the mapping the extracted first command code to the first requested action.

11. The method of claim 10, further comprising encoding, by the mobile device, a second requested action into a second command frame formatted for wireless transmission, the second command frame comprising a second command code identifying the second requested action,
wherein the second command code is different from the first command code, and wherein the second command frame comprises a first data field causing the second command frame to contain more bytes than the first command frame.

12. The method of claim 11, wherein the second requested action comprises setting a temperature setpoint value, and wherein the first data field comprises the temperature setpoint value.

13. The method of claim 10, wherein performing the first requested action comprises retrieving a sensor reading from memory within the refrigeration controller.

14. The method of claim 10, wherein the first command frame further comprises a checksum, the method further comprising:
calculating, by the mobile device, the checksum as a modulus of a sum of decimal values of standard ASCII characters in the first command frame; and
appending, by the mobile device, the checksum to the first command frame.

15. The method of claim 10, further comprising:
encoding, by the refrigeration controller, a first result of performing the first requested action into a first response frame formatted for wireless transmission, the first response frame comprising a first response code identifying the first result of performing the first requested action; and
sending the first response frame from the refrigeration controller to the mobile device.

16. The method of claim 15, wherein the first response code is generated by appending the first result identifier to the first command code.

17. The method of claim 15, further comprising:
encoding, by the refrigeration controller, a second result of performing a second requested action into a second response frame formatted for wireless transmission, the second response frame comprising a second response code identifying the second result of performing the second requested action,
wherein the second response code is different from the first response code, wherein the first response frame comprises a second data field causing the first response frame to contain more bytes than the second response frame.

18. The method of claim 10, further comprising:
receiving, by a bridge device, the first command frame from the mobile device; and
sending by the bridge device, the first command frame to the refrigeration controller.

19. A non-transitory computer-readable storage medium having instructions stored thereon that, upon execution by a computing device, cause the computing device to perform operations comprising:
receiving a user input requesting a first action to be performed by a refrigeration controller;
encoding the first requested action into a first command frame formatted for wireless transmission, the first command frame comprising a first command code identifying the first requested action;
sending the first command frame from a mobile device to the refrigeration controller;
extracting the first command code from the first command frame and mapping the extracted first command code to the first requested action; and
performing the first requested action in response to the mapping the extracted first command code to the first requested action.

20. The storage medium of claim 19, the operations further comprising encoding a second requested action into a second command frame formatted for wireless transmission, the second command frame comprising a second command code identifying the second requested action,
wherein the second command code is different from the first command code, and wherein the second command frame comprises a first data field causing the second command frame to contain more bytes than the first command frame.
